(19) United States
(12) Patent Application Publication
(10) Pub. No.: US 2016/0223114 A1
(43) Pub. Date: Aug. 4, 2016

(54) EASY CONNECT LIQUID FLOW CONTROL SYSTEM

(71) Applicant: Bert Joseph Achez, Topanga, CA (US)

(72) Inventor: Bert Joseph Achez, Topanga, CA (US)

(21) Appl. No.: 15/005,742

(22) Filed: Jan. 25, 2016

Related U.S. Application Data
(60) Provisional application No. 62/125,854, filed on Feb. 3, 2015.

(51) Int. Cl. F16L 37/47; F16L 15/00; F16L 37/26

(52) U.S. Cl. CPC F16L 37/47; F16L 37/26; F16L 15/00

(57) ABSTRACT

Systems and devices are described for quickly connecting an external device to a flow control device. In some examples, a liquid flow control device is provided that includes a quick connect-disconnect male coupler, and a quick connect-disconnect female coupler is provided for connecting to the male coupler. Together, the quick connect-disconnect male coupler and the quick connect-disconnect female coupler form a quick connect-disconnect coupling. The quick connect-disconnect coupling allows the external device to be easily connected and disconnected to the flow-control device.

### CROSS-REFERENCE TO RELATED APPLICATIONS

This application claims the benefit of U.S. Provisional Application No. 62/125,854, filed Feb. 3, 2015, which is hereby incorporated by reference in its entirety.

### FIELD

The present disclosure relates generally to a flow control system, and more specifically to an easy connect liquid flow control system.

### BACKGROUND

Valves can be used to control the flow of a liquid from one location to another. For instance, liquid water supply or shutoff valves can direct and control water flow. Water travels through a passageway within the water supply valve, and can be regulated using the valve. Many valves include threaded connections that are difficult for attaching external devices.

### SUMMARY

Systems and devices are described that include tools for quickly connecting an external device (e.g., a tool for dispensing a liquid, a liquid-powered tool, or other device) to a flow control device (or valve). In some examples, a liquid flow control device is provided that includes a quick connect-disconnect male coupler, and a quick connect-disconnect female coupler is provided for connecting to the male coupler. Together, the quick connect-disconnect male coupler and the quick connect-disconnect female coupler form a quick connect-disconnect coupling. The quick connect-disconnect coupling allows the external device to be easily connected and disconnected to the flow-control device.

In some embodiments, a liquid flow control device is provided. The liquid flow control device includes a first end for receiving a liquid from a liquid source. The first end includes a connection component. The connection component is configured to connect to the liquid source. For example, the connection component can attach to the liquid source, such as a pipe or other source of liquid. The liquid flow control device further includes a second end providing an exit point for the liquid from the liquid flow control device. The second end includes a male coupler connection component. The male coupler connection component has a groove circumscribing an outer circumference of the second end for securing a female coupler connection component to the male coupler connection component. The male coupler connection component and the female coupler connection component form a quick connect-disconnect coupling. The liquid flow control device further includes a body connecting the first end and the second end. The body can be of any suitable shape, including a tubular shape, or a tubular shape with an opening portion at the top (or other position) of the body. The liquid flow control device further includes a regulator for regulating flow of the liquid from the first end to the second end. The regulator is coupled to the body. In some examples, the regulator can protrude out of an opening in the top (or other position) of the body.

In some examples, the regulator includes a stem for controlling an amount of liquid flowing from the first end to the second end. The regulator can also include a lever coupled to the stem. The lever is adjustable to rotate the stem to increase or decrease the amount of liquid flowing from the first end of the liquid flow control device to the second end of the liquid flow control device.

In some examples, the regulator includes a bonnet including threading on an inner portion of the bonnet for mounting to outer threading of a gland nut. In such examples, the regulator further includes the gland nut circumscribing the stem.

In some examples, the regulator includes a threaded spindle within the stem. In some embodiments, the stem and the threaded spindle at least partially protrude out of the body (e.g., out of an opening in the body). In such embodiments, the regulator further includes a screw coupled to the threaded spindle. The screw secures the lever to the stem. The regulator further includes a bonnet with threading on an inner portion of the bonnet for mounting to the threaded spindle. The regulator further includes a packing substance circumscribing the stem for providing a sealant between the stem and the bonnet, and a gland nut circumscribing the stem for compressing the packing substance.

In some examples, the regulator includes a ball valve, a butterfly valve, a cock and plug valve, or a globe valve.

In some examples, the female coupler connection component is part of a quick connect-disconnect female coupler, the female coupler connection component having one or more protuberances for securing to the groove circumscribing the outer circumference of the male coupler connection component of the liquid flow control device, wherein the quick connect-disconnect female coupler includes a second end providing an exit point for the liquid from the quick connect-disconnect female coupler, the second end including a connection component configured to connect to an external device.

In some examples, the one or more protuberances of the female coupler connection component include a plurality of ball bearings seated in concave openings at the first end.

In some examples, the connection component of the second end of the quick connect-disconnect female coupler includes internal threads for securing the second end to threads of the external device.

In some examples, the connection component of the second end of the quick connect-disconnect female coupler includes one or more protuberances for securing to a groove around an outer circumference of a male coupler connection component of the external device.

In some embodiments, a quick-connect liquid transport system is provided that includes the liquid flow control device and the quick connect-disconnect female coupler. For example, the quick-connect liquid transport system includes a liquid flow control device including: a first end for receiving a liquid from a liquid source, the first end including a connection component, the connection component being configured to connect to the liquid source; a second end providing an exit point for the liquid from the liquid flow control device, the second end including a male coupler connection component, the male coupler connection component having a groove circumscribing an outer circumference of the second end for securing a female coupler connection component to the male coupler connection component, wherein the male coupler connection component and the female coupler connection component form a quick connect-disconnect coupling; a body connecting the first end and the second end; and a regulator for regulating flow of the liquid from the first end to the second end, the regulator being coupled to the body. The quick-connect liquid transport system further includes a quick connect-disconnect female coupler, including: a first end for receiving a liquid from the liquid flow control device, the first end including the female coupler connection component, the female coupler connection component having one or more protuberances for securing to the groove circumscribing the outer circumference of the male coupler connection component of the liquid flow control device; and a second end providing an exit point for the liquid from the quick connect-disconnect female coupler, the second end including a connection component, the connection component being configured to connect to an external device.

In some embodiments, an easy-connect valve may be provided, including: a tubular body having a first end and a second end, a surface of the first end of the tubular body having a plurality of threads for connecting to a water supply; a water flow regulator within the tubular body; and a quick connect-disconnect coupling at the second end of the tubular body for connecting to an external device (e.g., a hose or other tool that uses liquid).

In some embodiments, a male coupler (also referred to herein as a liquid flow control device) is provided that is constructed and arranged for connection to a mating female coupler (e.g., that is connected to an external device). The male coupler can also be referred to as a liquid flow control device. The male coupler can include: an open first end (e.g., having a plurality of threads on surface for connecting to an incoming water supply); an open second end circumscribed by a groove for locking and unlocking the mating female coupler to and from the male coupler, the male coupler and mating female coupler forming a quick connect-disconnect coupling for connecting to an external device; a tubular body connecting the first and second ends of the male coupler together; a passageway inside the tubular body open on the first end through to the open second end; and a seat in the passageway allowing water flow. The male coupler includes a regulator portion for regulating the flow of liquid from the open first end to the open second end. For example, the regulator portion includes: a disc adjacent the seat for making an adjustable seal with the seat, the adjustable seal regulating the amount of water flow through the male coupler; a stem connected to the disk that transmits the motion of the disc to and from the seat by turning the disc one or more directions to open or close the passageway; a seat washer at the bottom of the disc to make a water tight seal with the seat; a screw to hold the seat washer in place; a threaded spindle in the bottom center of the stem to receive a screw for securing the washer; a threaded area on the circumference of the stem for screwing the stem to and from the seat; a bonnet circumscribing the stem and holding the steam and internal valve parts together; a threaded spindle on the interior of the bonnet to mesh with the exterior threads of the steam; a rounded head at the top of the body; a threaded area on the circumference of the bonnet; a threaded spindle through the head penetrating into the interior passageway of the body to screw the bonnet into securing the regulator into the male coupler; a shaped edge (e.g., in the shape of a square, a rectangle, a triangle, a hexagon, or other suitable shape) on the outside circumference of the bonnet for tightening the bonnet into the body; a packing circumscribing the stem above the bonnet for sealing between the stem and bonnet; a protruding edge around the inside circumference of the gland nut to support the packing; a gland nut circumscribing the steam and compressing the packing in place; a rounded head on the top of the bonnet; a threaded spindle inside the top of the bonnet head to screw the gland nut into; a shaped edge (e.g., in the shape of a square, a rectangle, a triangle, a hexagon, or other suitable shape) on the outside circumference of the gland nut for tightening it into the bonnet body; an adjustment device (e.g., a lever, a handle, a push button, or other suitable adjustment device) connected to the stem to control the stem from outside of the male coupler body; a threaded spindle inside the top of the steam to receive a screw; and a screw to secure the handle to the stem.

In some embodiments, a quick-connect female coupler is provided. For example, the quick-connect female coupler can include: an open first end; an open interior passageway from the first end to and internally-threaded open second end; an outer surface and an inner surface; a plurality of protuberances at a first end of the outer surface; a plurality of protuberances at a second end of the outer surface, the protuberances at the first and second ends of the outer surface providing a grooved, rough surface for non-slip gripping of the female coupler; a circular surface in the passageway, the surface including an opening through center thereof; a washer on outer rear side of the circular surface; a plurality of threads on interior of back end of the passageway, to accommodate a hose or other external device connection thereto; an O-ring disposed within inner surface near a first end of the female coupler, for stopping water flow; a first groove in which the O-ring is seated; a plurality of ball bearings seated in concave openings near a second end of the female coupler; an outer sleeve surrounding the ball bearings, which float freely in the sleeve; a cylindrical member having an outer surface on which the sleeve slides; a spring resting against a thicker outside surface of the cylindrical member, for urging the sleeve to a closed or locked configuration; a snap ring disposed in front of and retaining the sleeve; and a second groove in which the snap ring is seated.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will be described in more detail below in the following specification, claims, and accompanying drawings.

### BRIEF DESCRIPTION OF DRAWINGS

Illustrative embodiments of the present invention are described in detail below with reference to the following drawing figures:

FIG. 1 is a partial cross-sectional view of an example flow control system, in accordance with an embodiment of the present disclosure.

FIG. 2 is a side view of an example flow control system with a flow control device connected to an external device, in accordance with an embodiment of the present disclosure.

FIG. 3 is a partial cross-sectional view of an example regulator of a flow control system, in accordance with an embodiment of the present disclosure.

FIG. 4 is an exploded perspective view of an example quick connect-disconnect female coupler, in accordance with an embodiment of the present disclosure.

FIG. 5 is another exploded perspective view of the example quick connect-disconnect female coupler, in accordance with an embodiment of the present disclosure.

### DETAILED DESCRIPTION

In the following description, for the purposes of explanation, specific details are set forth in order to provide a thorough understanding of embodiments of the disclosure. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

Water supply shutoff valves are provided for connecting external devices to a water source. For example, water can travel through a passageway within the water supply shutoff valve, and can be regulated by the valve that can open or close the passageway by varying degrees. There is a need for a fast and efficient way to connect and disconnect an external device to a water supply shut-off valve without the need for tools or adaptations to the water supply shut-off valve.

Systems and devices are described herein that include tools for quickly connecting an external device to a flow control device (or valve) for liquid distribution. External devices can include any device that connects to a water supply, such as a tool for dispensing a liquid (e.g., a garden hose, a pressure washing system, an oil dispensing device, a spray nozzle, or other tool), a liquid-powered tool, a sink, a toilet, a fire hydrant, or other external device that is supplied with or uses water. As described in detail below, a liquid flow control device is provided that includes a quick connect-disconnect male coupler. A quick connect-disconnect female coupler is also provided for connecting to the male coupler. Together, the quick connect-disconnect male coupler and the quick connect-disconnect female coupler form a quick connect-disconnect coupling. The quick connect-disconnect coupling allows an external device to be easily connected and disconnected to the flow-control device.

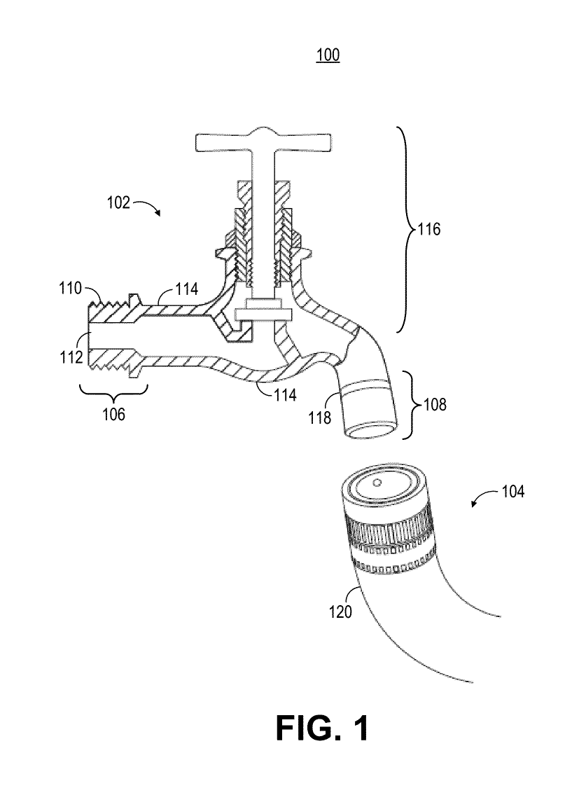

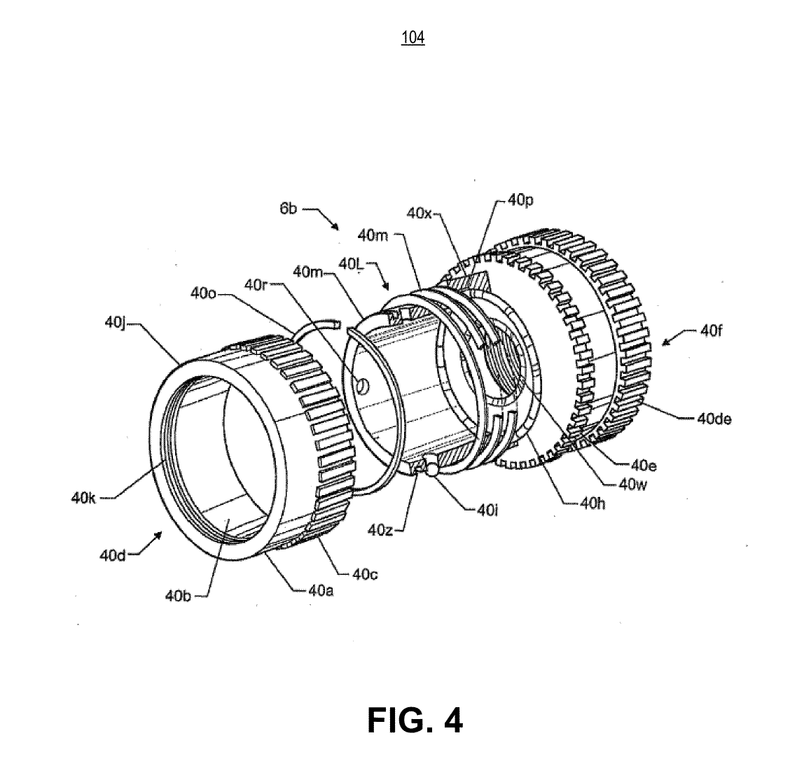

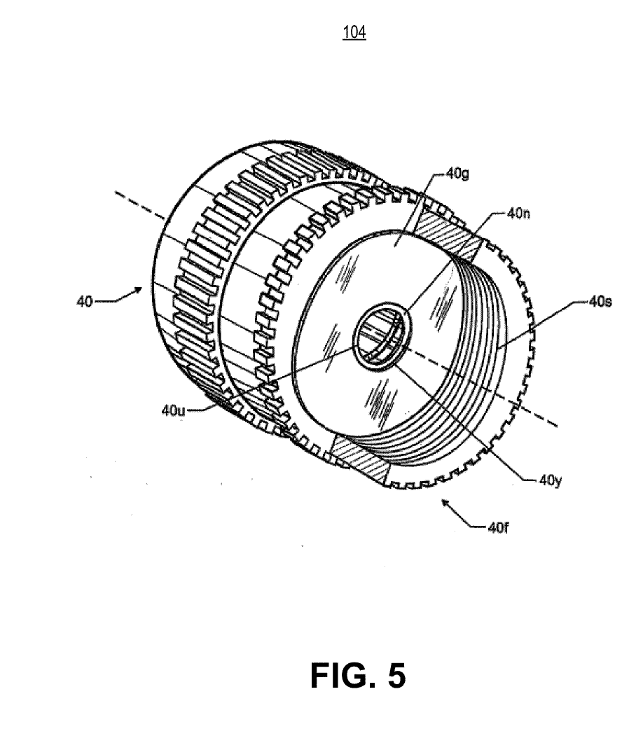

FIG. 1 illustrates a partial cross-sectional view of an example flow control system 100. The flow control system 100 includes a liquid flow control device 102 and a quick connect-disconnect female coupler 104. Details of the quick connect-disconnect female coupler 104 are described below with respect to FIG. 4 and FIG. 5. The liquid flow control device 102 includes a first end 106 for receiving a liquid from a liquid source (not shown). The first end 106 includes a connection component 110 that is configured to connect to the liquid source. In one example, the connection component 110 includes external threads that can screw into internal threads of the liquid source. In some examples, the liquid source can include a pipe that provides liquid from a public utility, a well, or other location that includes liquid. While the connection component 110 is shown as having male external threads, one of ordinary skill in the art will appreciate that the connection component can include any other means of connecting to the liquid source, such as female internal threads that can screw onto external threads of the liquid source, a quick connect-disconnect coupling, a solder-on coupling, compression, or any other suitable connecting means.

The liquid flow control device 102 also includes a body 114 that connects the first end 106 to a second end 108. The body 114 can be tubular in shape, square in shape, hexagonal in shape, octagonal in shape, or have any other suitable shape for facilitating connection of the liquid flow control device 102 to the liquid source and to the female coupler connection component 104. The second end 108 provides an exit point for the liquid from the liquid flow control device 102. For example, the second end 108 can transfer liquid from the liquid flow control device 102 to an external device through the female coupler connection component 104. The second end 108 is or includes a male coupler connection component having a groove 118 circumscribing an outer circumference of the second end 108. The groove 118 operates to secure the female coupler connection component 104 to the male coupler connection component of the second end 108. Together, the male coupler connection component and the female coupler connection component 104 form a quick connect-disconnect coupling. For example, the male coupler connection component can mate with the female coupler connection component 104 to form a quick coupling. Because of the male coupler connection component and the female coupler connection component 104, the quick coupling is self-sealing. The self-sealing nature of the coupling prevents air or contaminates from entering the external device when the flow control system 100 is being used to provide water to the external device.

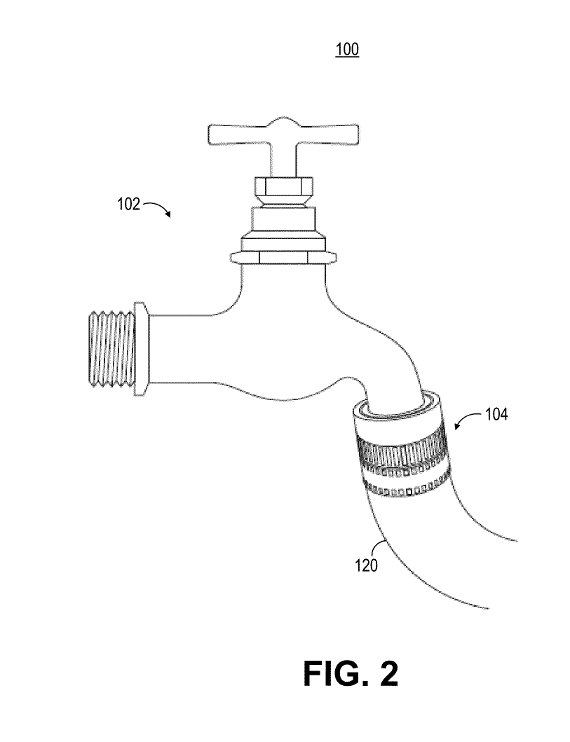

In one example shown in FIG. 2, the flow control system 100 can be used to connect the liquid flow control device 102 to a hose 120 using the quick connect-disconnect coupling between the male coupler connection component and the female coupler connection component 104, allowing water to be conveyed to a spray nozzle (not shown) connected to the hose 120. In another example, the male coupler connection component attaches to a hose using the quick connect-disconnect coupling between the male coupler connection component and the female coupler connection component, and the hose can then attach to another external device, such as a nozzle, a sink, a toilet, or other device requiring a water supply. For instance, a water stop valve that supplies a toilet could quick connect to a hose using a quick connect coupling at one end of the hose, and the other end of the hose can quick connect to the flow control device 102 male end coupler connection component using the female coupler connection component 104.

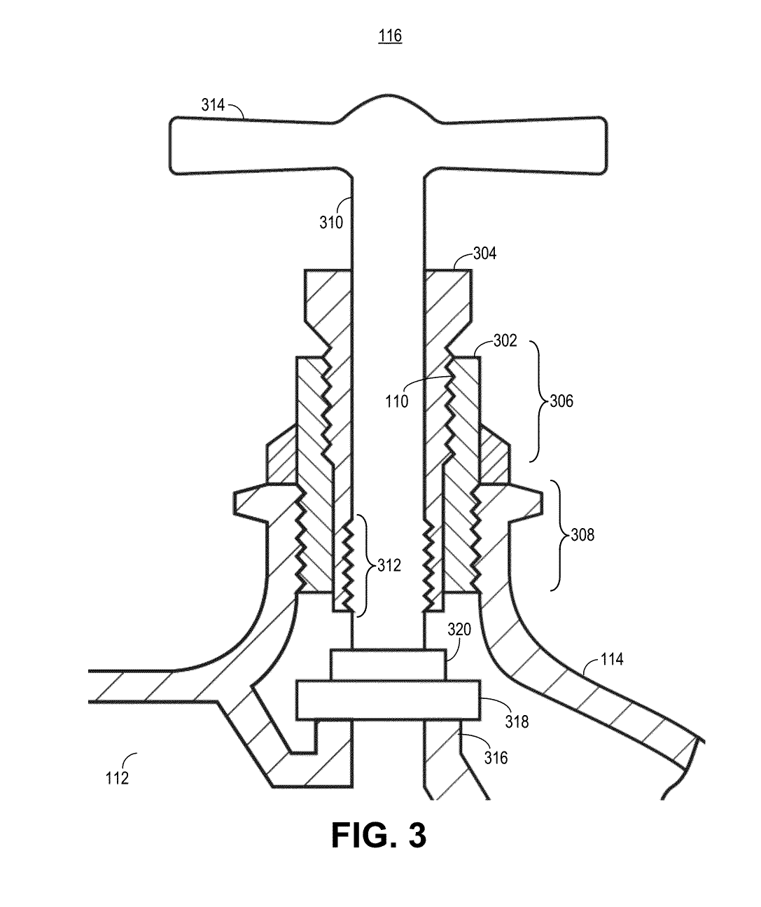

The flow control system 100 works well when the quick connect-disconnect coupling connects to an external device that can be regulated from a liquid flow perspective. As used herein, regulation of a liquid supply can refer to turning the liquid on and off, or can refer to regulating different amounts of liquid to the external device. To that end, the body 114 is coupled to a regulator 116 for controlling and regulating flow of the liquid from the first end 106 to the second end 108. Inside of the body 114 is a passageway 112 from the front end 106 to the second end 108. The regulator 116 intersects the body 114 to regulate water flow through the passageway 112. Reference is made to FIG. 3 to describe details of an example of the regulator 116. One of ordinary skill in the art will appreciate that the regulator 116 shown in FIG. 1 and FIG. 3 is only an example, and that any type of regulator or valve can be used in the liquid flow control device 102. For example, the regulator 116 could include a butterfly valve, a cock and plug valve, a globe valve, a ball valve, or any other type of valve that can control the flow of a liquid from the first end 106 of the liquid flow control device 102 to the second end 108.

FIG. 3 shows a partial cross-sectional view of the regulator 116 of the liquid flow control device 102. In some embodiments, the regulator 116 includes a bonnet 302 including threading on an inner portion of the bonnet 302 for mounting to outer threading of a gland nut 304 circumscribing a stem 310. For example, the regulator 116 includes the bonnet 302. The bonnet 302 has external threads circumscribing a lower portion of the bonnet 302. The external threads mesh with or screw into internal threads inside the body 114 to create a bonnet-body coupling 308 for mounting the regulator 116 to the body 114 creating a sealed connection. In some embodiments, the bonnet 302 can have a shaped edge (e.g., a hexagonal shape, a square shape, an octagonal shape, or other suitable shape) that allows the bonnet 302 to be easily tightened into the valve body 114.

The regulator 116 also includes a stem 310 that attaches to the body 114 through the center of the bonnet 302 and a gland nut 304. The stem 310 controls an amount of liquid flowing from the first end 106 to the second end 108. In some embodiments, packing substance can be provided that circumscribes the stem 310 for providing a sealant between the stem 310 and the bonnet 302. The gland nut 304 has external threads around the circumference of a middle portion of the gland nut 304. The external threads of the gland nut 304 screw into internal threads circumscribing a top portion of the bonnet 302 to create a bonnet-gland nut coupling 306. By screwing the gland nut 304 into the bonnet 302, the packing substance is compressed against the inside circumference of bonnet 302 to create a watertight seal with the gland nut 304 and the stem 310. The packing substance also helps to support the stem 310. In some embodiments, the gland nut 304 can have a shaped edge at a top portion (e.g., a hexagonal shape, a square shape, an octagonal shape, or other suitable shape) that allows the gland nut 304 to be easily tightened into the bonnet 302.

The stem 310 includes external threads around the circumference of a bottom portion of the stem 310. The external threads of the stem 310 screw into internal threads circumscribing a bottom portion of the gland nut 304 to create a stem-gland nut coupling 312. In some embodiments, the external threads of the stem 310 screw into internal threads circumscribing a bottom portion of the bonnet 302 (instead of internal threads of the gland nut 304 that are shown in FIG. 3) to create a stem-bonnet coupling (not shown). In such embodiments, the gland nut 304 may terminate above the external threads around the circumference of the bottom portion of the stem 310. The stem-gland nut coupling 312 (or the stem-bonnet coupling in alternative embodiments) allows the stem 310 to be adjusted toward or away from the passageway 112 of the liquid flow control device 102. As shown in FIG. 3, the stem 310 can be adjusted using a lever 314 that is coupled to the stem 310. The lever 314 is adjustable to rotate the stem 310 to increase or decrease the amount of liquid flowing from the first end 106 to the second end 108. The lever 314 can be permanently coupled or connected (and thus part of) to the stem 310. In other embodiments not shown in FIG. 3, the lever 314 can be removably coupled to the stem 310, for example using a screw with external threads that can be screwed through the middle of the lever 314 into internal threads at a top portion of the stem 310. For example, a threaded spindle in the top center of the steam 310 can receive the screw to secure the lever 314 onto the steam 310. Thus, in some embodiments, the regulator 116 includes a threaded spindle within the stem 310, in which case the stem 310 and the threaded spindle at least partially protrude out of the body 114. In such embodiments, the regulator 116 can further include a screw that screws into or is otherwise coupled to the threaded spindle in the stem 310, with the screw securing the lever 314 to the stem 310.

As the stem 310 is adjusted toward the passageway 112, water is restricted, and as the stem 310 is adjusted away from the passageway 112, water flow through the passageway 112 is encouraged. A seat 316 provides a gateway for water flow through the passageway 112. A disc 320 at the bottom of the stem 310 is adjacent the seat 316. The disc 320 can be permanently or removably connected to the stem 310. For example, the disc 320 can be part of the stem 310 so that it cannot be removed from the stem 310. In such an example, the disc 320 is small enough to go through the passageway of the gland nut 304 and/or the bonnet 302. In another example, the disc 320 can be removable coupled to the stem 310 using a screw or other connection mechanism. As the lever 314 turns the steam 310 in one direction or the other, the disc 320 moves closer to or away from the seat 316, which opens or closes the passageway 112 to regulate the amount of water flow through the liquid flow control device 102. For example, turning the lever 314 in a clockwise direction can cause the disc 320 to move closer to the seat 316, causing flow of water through the passageway 112 to be restricted. Turning the lever 314 in a counter-clockwise direction can cause the disc 320 to move away from the seat 316, causing flow of water through the passageway 112 to be increased. A seat washer 318 at the bottom of the disc 320 can be provided to make a watertight seal between the disc 320 and the seat 316 when the regulator 116 is in a fully closed position (e.g., the lever 314 is turned clockwise until the disc 320 is fully compressed against the washer 318 and seat 316.

FIG. 4 and FIG. 5 illustrate exploded perspective views of a quick connect-disconnect female coupler 104. The quick connect-disconnect female coupler 104 includes a quick connect first end 40d for connecting to the male coupler connection component of the second end 108 of the liquid flow control device 102 shown in FIG. 1, allowing regulated amounts of liquid to flow from the liquid flow control device 102 to an external device through the quick connect-disconnect female coupler 104. The quick connect-disconnect female coupler 104 is also referred to herein as the female coupler 104. The female coupler 104 has an outer surface 40aand an inner surface 40b. In some embodiments, the outer surface 40a has two sets of protuberances 40c at a first end 40d, and a plurality of smaller protuberances 40e and 40de at a second end 40f. The protuberances 40c, 40e, and 40de provide a grooved, rough surface for non-slip gripping of the female coupler 104. In other embodiments, the female coupler 104 has no protuberances, or has fewer or more protuberances than those shown in FIG. 4 and FIG. 5.

The first end 40d of the female coupler 104 is open, and can be openly connected to the second end 40f. The second end 40f is open and has a connection component with internal threads 40s for connecting to a male threaded portion of an external device. In other embodiments, the second end 40f can have a connection component with external threads, can have a female quick connect coupling component, can including a permanent connection to the external device, or can have any other suitable attachment mechanism for attaching to the external device. For example, the connection component of the second end of the quick connect-disconnect female coupler can include one or more protuberances (e.g., ball bearings) for securing to a groove around an outer circumference of a male coupler connection component of the external device.

As shown in FIG. 5, a washer 40g is disposed at the rear of and on an interior surface 40n of the second end 40f. The interior surface 40n has a circular indented edge 40u and an opening 40w (FIG. 4) centered in a passageway 40y. An O-ring 40h is disposed within the inner surface 40b near the second end 40f of the female coupler 104. The O-ring 40h is seated in a groove 40p. The washer 40g forms a sealed passageway 40y for liquid to the external device. When coupled to the female coupler 104, the male coupler connection component of the liquid flow control device 102 fits tightly in and through the O-ring 40h to form a seal for the passageway 40y. The result is a watertight connection from a water source to an external device with speed, ease, and security, allowing a controlled supply of water to the external device.

Near the first end 40d of the female coupler 104 are three circumferentially spaced ball bearings 40i at the front-end 40d of the cylindrical member 40l. One of ordinary skill in the art will appreciate that other protuberances other than ball bearings can be used to secure the female coupler 104 to the male coupler connection component of the liquid flow control device 102. The ball bearings 40i can be evenly spaced around the circumference of the cylindrical member 40l. The ball bearings 40i are seated in concave openings 40r that are smaller than the ball bearings 40i, so that the ball bearings 40i can only partially protrude through the openings 40r. The ball bearings 40i float freely against an outer surrounding sleeve 40j that can be slide over the cylindrical member 40l. The inside front-end surface 40k of the sleeve 40j is tapered, and slides on the outer surface of a cylindrical member 401. A spring 40m surrounding the cylindrical member 40l biases the sleeve 40j to a closed or locked configuration in which the sleeve 40j is pressed against the O-ring 40h. In this configuration, the inside surface 40k of the tapered sleeve 40j is thickest, causing a downward pressure against the ball bearings 40i. The downward pressure pushes the ball bearings 40i into the groove 118 surrounding the male coupler connection component of the liquid flow control device 102. When the ball bearings 40i are pushed into the groove 118, the ball bearings 40i are pressed hard against the groove 118, seating the ball bearings 40i firmly in the openings 40r and into the groove 1. A seal is thus created between the coupler connection component of the liquid flow control device 102 and the O-ring 40h. The springs 40m rests against a thicker outside surface 40x of the second end 40f and around the cylindrical member 40l, keeping the sleeve 40j in a locked configuration. A snap ring 40o fits in front of and retains the sleeve 40j, and is seated in a groove 40z. If the sleeve 40j is pushed toward the first end 40d of the female coupler 104, the ball bearings 40i are disengaged, and the male coupler connection component of the liquid flow control device 102 is released from the female coupler 104. In some embodiments, the female coupler 104 can be permanently attached to the external device, not requiring the threaded second end 40f.

A number of embodiments of the disclosure have been described. Nevertheless, it will be understood that various modification may be made without departing from the scope of the disclosure. Other components may be added to, or removed from, the described systems. Accordingly, other implementations are within the scope of the following claims.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

What is claimed is:

1. A liquid flow control device, comprising:
a first end for receiving a liquid from a liquid source, the first end including a connection component, the connection component being configured to connect to the liquid source;
a second end providing an exit point for the liquid from the liquid flow control device, the second end including a male coupler connection component, the male coupler connection component having a groove circumscribing an outer circumference of the second end for securing a female coupler connection component to the male coupler connection component, wherein the male coupler connection component and the female coupler connection component form a quick connect-disconnect coupling;
a body connecting the first end and the second end; and
a regulator for regulating flow of the liquid from the first end to the second end, the regulator being coupled to the body.

2. The liquid flow control device of claim 1, wherein the regulator includes:
a stem for controlling an amount of liquid flowing from the first end to the second end; and
a lever coupled to the stem, the lever being adjustable to rotate the stem to increase or decrease the amount of liquid flowing from the first end to the second end.

3. The liquid flow control device of claim 1, wherein the regulator further includes:
a bonnet including threading on an inner portion of the bonnet for mounting to outer threading of a gland nut; and
the gland nut circumscribing the stem.

4. The liquid flow control device of claim 1, wherein the regulator includes a ball valve.

5. The liquid flow control device of claim 1, wherein the female coupler connection component is part of a quick connect-disconnect female coupler, the female coupler connection component having one or more protuberances for securing to the groove circumscribing the outer circumference of the male coupler connection component of the liquid flow control device, wherein the quick connect-disconnect female coupler includes a second end providing an exit point for the liquid from the quick connect-disconnect female coupler, the second end including a connection component configured to connect to an external device.

6. The liquid flow control device of claim 5, wherein the one or more protuberances of the female coupler connection component include a plurality of ball bearings seated in concave openings at the first end.

7. The liquid flow control device of claim 5, wherein the connection component of the second end of the quick connect-disconnect female coupler includes internal threads for securing the second end to threads of the external device.

8. The liquid flow control device of claim 5, wherein the connection component of the second end of the quick connect-disconnect female coupler includes one or more protuberances for securing to a groove around an outer circumference of a male coupler connection component of the external device.

9. A quick-connect liquid transport system, comprising:
a liquid flow control device including:
a first end for receiving a liquid from a liquid source, the first end including a connection component, the connection component being configured to connect to the liquid source;
a second end providing an exit point for the liquid from the liquid flow control device, the second end including a male coupler connection component, the male coupler connection component having a groove circumscribing an outer circumference of the second end for securing a female coupler connection component to the male coupler connection component, wherein the male coupler connection component and the female coupler connection component form a quick connect-disconnect coupling;
a body connecting the first end and the second end; and
a regulator for regulating flow of the liquid from the first end to the second end, the regulator being coupled to the body; and
a quick connect-disconnect female coupler, including:
a first end for receiving a liquid from the liquid flow control device, the first end including the female coupler connection component, the female coupler connection component having one or more protuberances for securing to the groove circumscribing the outer circumference of the male coupler connection component of the liquid flow control device; and
a second end providing an exit point for the liquid from the quick connect-disconnect female coupler, the second end including a connection component, the connection component being configured to connect to an external device.

10. The quick-connect liquid transport system of claim 9, wherein the regulator includes:
a stem for controlling an amount of liquid flowing from the first end of the liquid flow control device to the second end of the liquid flow control device; and
a lever coupled to the stem, the lever being adjustable to rotate the stem to increase or decrease the amount of liquid flowing from the first end of the liquid flow control device to the second end of the liquid flow control device.

11. The quick-connect liquid transport system of claim 9, wherein the regulator further includes:
a bonnet including threading on an inner portion of the bonnet for mounting to outer threading of a gland nut; and
the gland nut circumscribing the stem.

12. The quick-connect liquid transport system of claim 9, wherein the regulator includes a ball valve.

13. The quick-connect liquid transport system of claim 9, wherein the one or more protuberances of the female coupler connection component include a plurality of ball bearings seated in concave openings at the first end.

14. The quick-connect liquid transport system of claim 9, wherein the connection component of the second end of the quick connect-disconnect female coupler includes internal threads for securing the second end to threads of the external device.

15. The quick-connect liquid transport system of claim 9, wherein the connection component of the second end of the quick connect-disconnect female coupler includes one or more protuberances for securing to a groove around an outer circumference of a male coupler connection component of the external device.
